(19) United States
(12) Patent Application Publication
(10) Pub. No.: US 2014/0363789 A1
(43) Pub. Date: Dec. 11, 2014

(54) Endosseous implant of the improved type

(71) Applicant: Massimo Simion, Milano (IT)

(72) Inventor: Massimo Simion, Milano (IT)

(73) Assignee: IMAX3 S.R.L., Negrar VR (IT)

(21) Appl. No.: 14/300,467

(22) Filed: Jun. 10, 2014

(30) Foreign Application Priority Data
Jun. 11, 2013 (IT) MI2013A000957

(51) Int. Cl. A61C 8/00

(52) U.S. Cl. CPC A61C 8/0024; A61C 8/0025; A61C 8/0075
USPC 433/174; 433/173

(57) ABSTRACT

An endosseous dental implant, of the type having a head equipped with a collar and a prosthesis connection, includes a body and an apical portion provided with an end, wherein the end has an edge with a sharp profile and a bottom having an elliptical form. In comparison to known implants with an apex having a rounded edge, an implant according to the present invention offers the advantage of improving the primary stability of the implant, also in the case of insertion in a bone of poor mechanical quality.

### FIELD OF THE INVENTION

The present invention relates to an endosseous implant of the improved type for dental applications.

### BACKGROUND OF THE INVENTION

The field of application of the invention relates to dental implants used for substituting missing dental elements at the level of the oral cavity. In particular, the implant substitutes the root of the tooth, thus allowing the application of a prosthesis which reproduces a tooth such as a crown.

Dental implants traditionally consist of cylindrical or more specifically conical bodies, with an apex having a rounded edge or in any case not sharp. This known embodiment, however, has the disadvantage of preventing the insertion of the implant in cavities already prepared with a specific milling, as in situations in which the pre-milling has an undersized diameter with respect to the dimensions of the implant, when the implant cannot be engaged inside its milled seat.

The known implants of the above described type in any case require a preparation of the bone seat with an opening, whose diameter is close to that of the implant. For this reason, the desired degree of primary stability, necessary for operating on the implant at the moment of its insertion in the bone, cannot be obtained. This requirement is particularly felt in the case of a receiving bone having a reduced mineralization, or in any case with insufficient mechanical characteristics for keeping the implant in a stable position, i.e. the condition necessary for ensuring the stability of the implant over time.

The known art also generally relates to implants having an apical area with a circular design, which increases the difficulty of inserting the implant in an undersized seat.

A further disadvantage of the known art is associated with the presence of millings at the apex, having an axial development or according to a generatrix of the body of the implant. This known embodiment, in fact, does not allow the outflow of bone chips produced during the insertion, said chips consequently blocking the progression of the implant in the bone tissue.

In order to increase the degree of primary stability of known implants, an outer surface has been developed having a roughness suitable for favoring osseointegration at the level of the bone/implant interface. This known solution, however, has the disadvantage of increasing the risk of bacterial adhesion and infection of the peri-implant tissues, resulting in a failure of the system in the medium and long term.

### SUMMARY OF THE INVENTION

The main objective of the present invention is therefore to provide a new endosseous dental implant which overcomes the above-mentioned drawbacks of the known art.

In particular, an implant according to the invention has the objective of ensuring a good primary stability, also in the presence of a soft bone or in general of a bone having a reduced consistency.

A further objective of the invention is to provide a dental implant suitable for facilitating its insertion in under-prepared locations and for limiting the accumulation of bone chips in the seat of the implant.

Another objective of the invention is to provide a dental implant of the above described type which, with respect to the implants of the known art, significantly reduces the risk of peri-implant infections, thus considerably increasing the medium- and long-term success of the implant.

These and other objectives are achieved with an implant having the features described hereinafter. Embodiments of the implant of the invention are described with particularity.

With respect to implants of the known art with an apex having a rounded edge, an implant according to the present invention offers the advantage of increasing the primary stability of the implant, also in case of insertion in a bone having a poor mechanical quality. The presence of millings with a helicoidal development, on the other hand, favors the outflow of bone chips resulting from the insertion of the implant in its seat.

Furthermore, due to the contribution of the previous features, the invention ensures the desired primary stability of the implant, also with the use of an outer surface which is no longer rough, but lathed with a smooth finish, thus considerably reducing the risk of bacterial proliferation.

Again, by exploiting the improved primary stability of an implant according to the invention, the implant has, from the outset, a stability which is sufficient for allowing the immediate application of a prosthesis suitable for sustaining the related masticatory load.

### BRIEF DESCRIPTION OF THE DRAWINGS

These and other objectives, advantages and characteristics are evident from the following description of a preferred embodiment of an implant according to the invention, illustrated, as a non-limiting example, in the figures of the enclosed drawings, in which:

FIG. 1 illustrates a perspective view of the apical end of an implant produced according to the known art;

FIG. 2 illustrates a perspective view of the apical end of an implant according to the invention;

FIGS. 3 and 4 illustrate an implant according to the invention from the side of its apical end;

FIG. 5 illustrates a front view of an implant according to the invention;

FIG. 6 illustrates an enlarged section of the implant of FIG. 5 according to line VI-VI;

FIG. 7 illustrates a detail of the head portion of the implant of FIG. 5;

FIG. 8 illustrates a perspective view of the implant of FIG. 5;

FIG. 9 illustrates the preparation of the bone for the insertion of an implant of the known art;

FIG. 10 illustrates the preparation of the bone for the insertion of an implant according to the invention; and

FIG. 11 illustrates the implant of FIG. 10 in situ.

### DETAILED DESCRIPTION OF EMBODIMENTS OF THE INVENTION

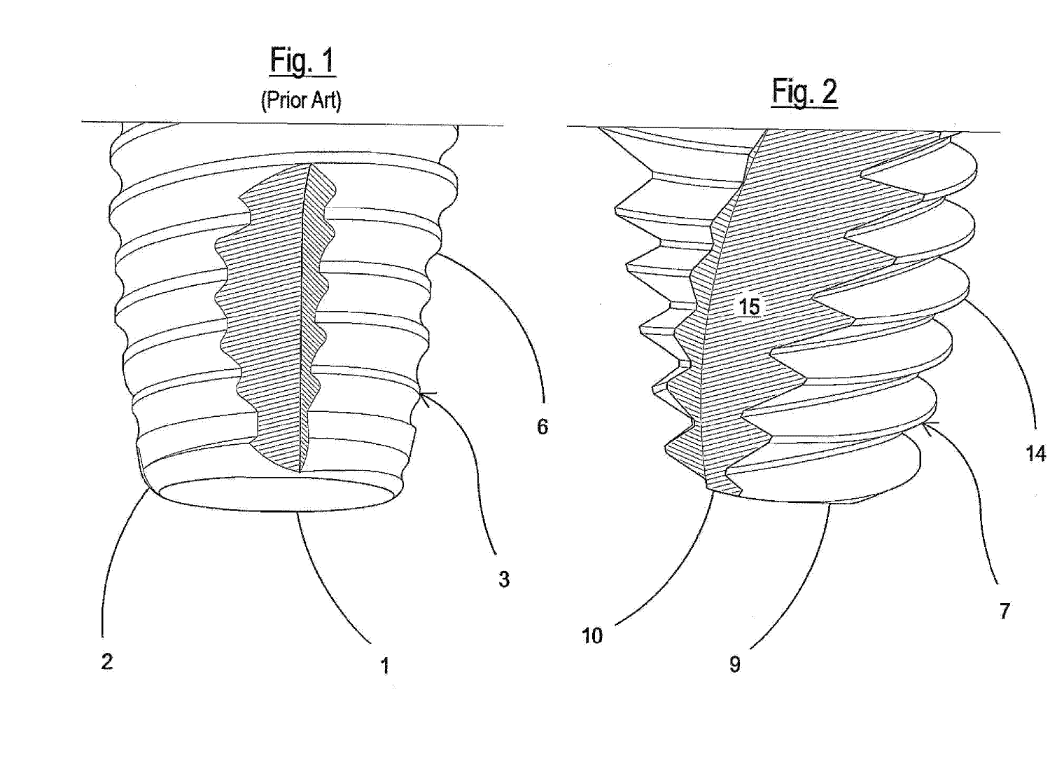

An implant 3 according to the known art is illustrated in FIG. 1 and has an apical end 1 having a rounded edge 2.

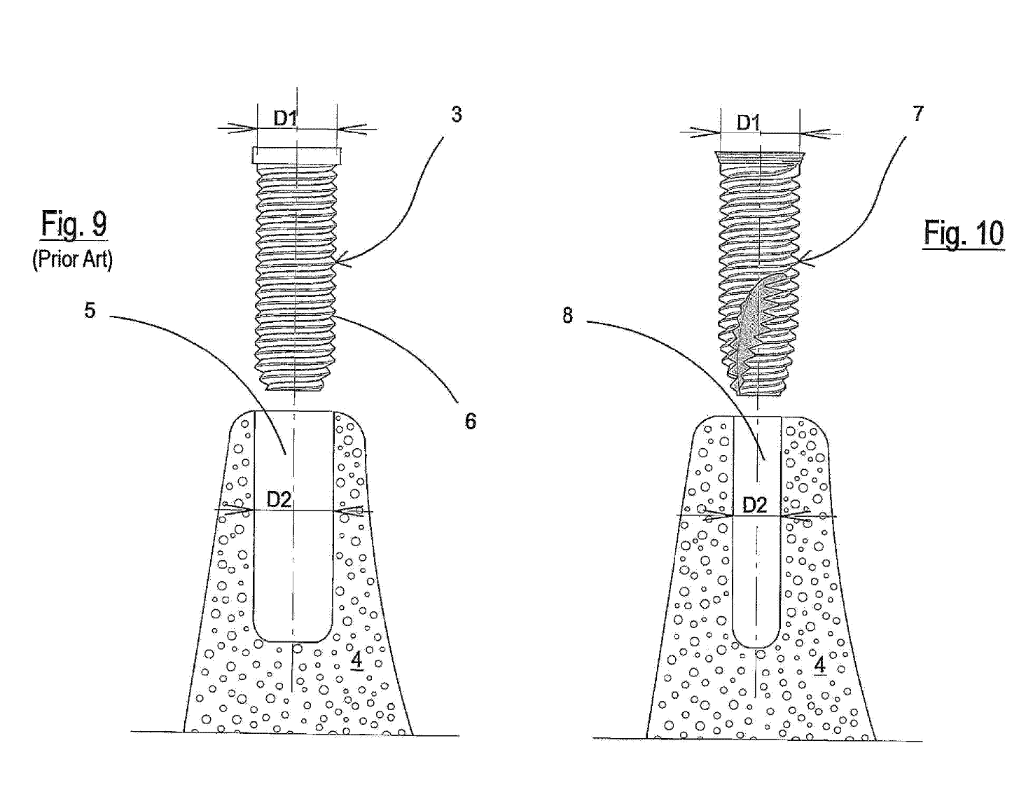

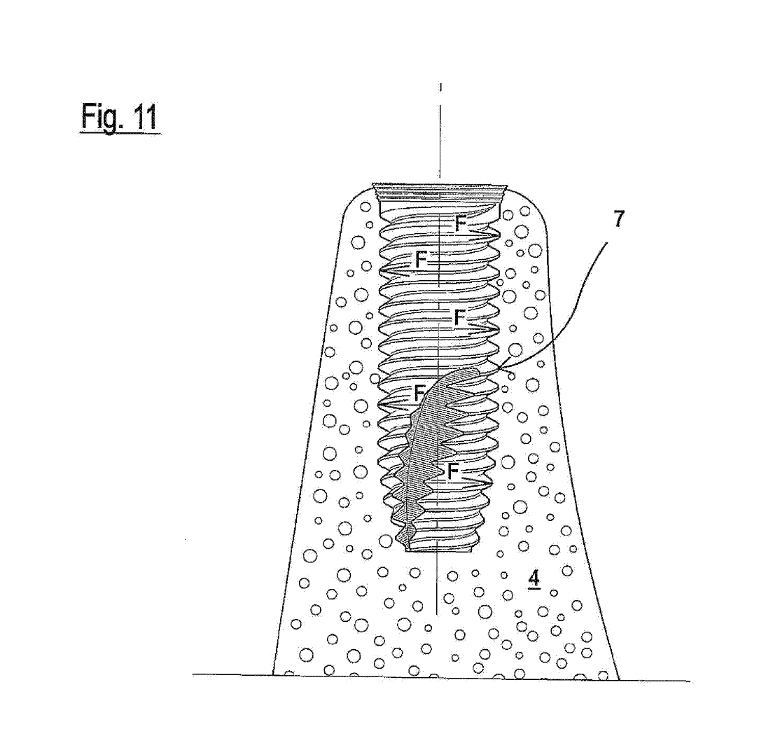

Due to the rounded edge 2 of the apex 1, and as illustrated in FIG. 9, the implant 3 of the known art having an outer diameter D1, requires, for its insertion into the bone 4, the previous formation in the bone of a corresponding circular seat 5, whose diameter D2 must correspond to the diameter D1 of the implant. This solution, however, jeopardizes the primary stability of the known implant 3 in its seat 5, above all in the case of a soft bone.

In order to compensate the described lack of primary stability, the known art provides for microroughness 6, on the outer surface of the implant 3, which, on the one hand favors the integration of the implant with the bone but, on the other hand, has the drawback of favoring the adhesion and growth of bacteria.

In order to overcome these drawbacks, the invention proposes the implant 7 of FIG. 10, which has the advantage of being configured to be inserted in a seat 8 whose diameter D2 is much smaller than the maximum diameter D1 of the implant 7. The ratio D1/D2, for example, can reach the value of 2/1, using an implant according to the invention. This way, an improved primary stability of the implant 7 can be obtained, in its seat 8 on the bone 4, due to the generation of forces F which insist on the inner side surface of the seat 8.

The increased primary stability shown by an implant according to the invention makes the use of traditional rough or wrinkled outer surfaces unnecessary, and enables using, on the contrary, smooth surfaces having an average roughness Ra lower than 0.7 μm, preferably equal to or lower than 0.5 μm, which have the advantage of reducing the risk of bacterial colonization.

These results are achieved, according to the invention, using a dental implant 7 whose apical portion 9 has an edge 10 with an edgy or sharpened profile.

The sharp profile of the apical portion 9 of an implant 7 according to the invention, combined with the truncated-conical design of the same apical portion 9, favors and facilitates the described penetration of the implant 7 into the seat 8 of the bone 4, even when seat 8 has a smaller diameter or is undersized with respect to the maximum diameter of the implant.

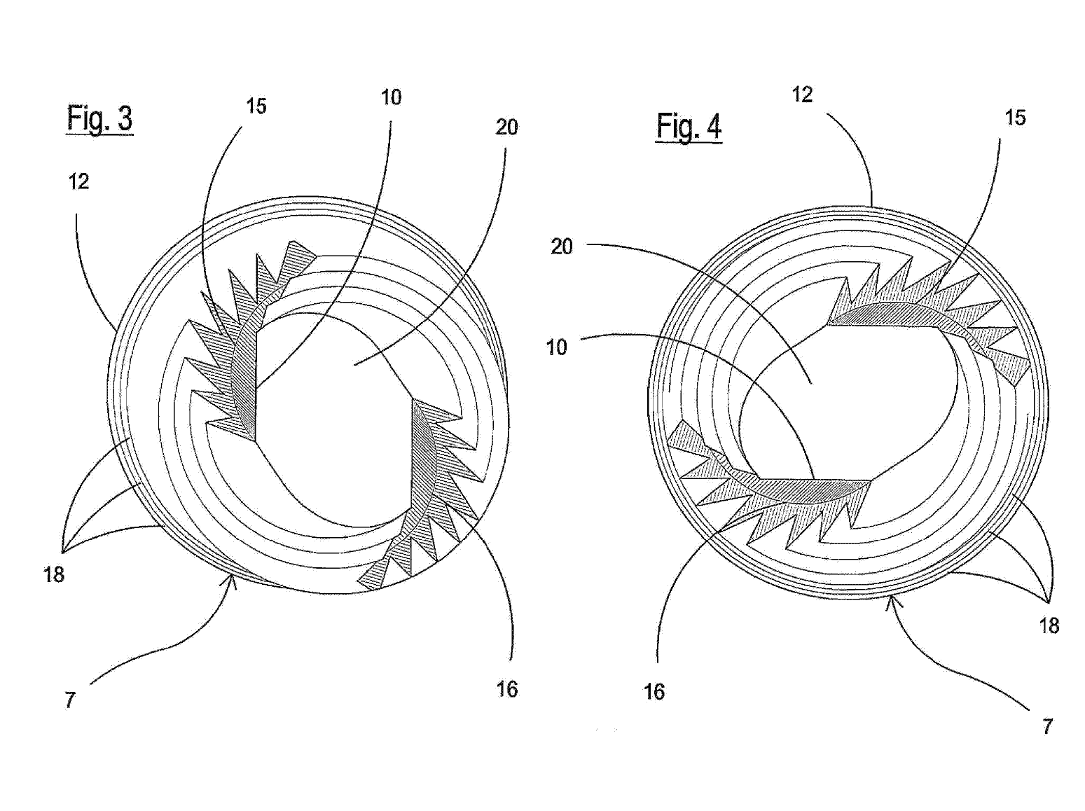

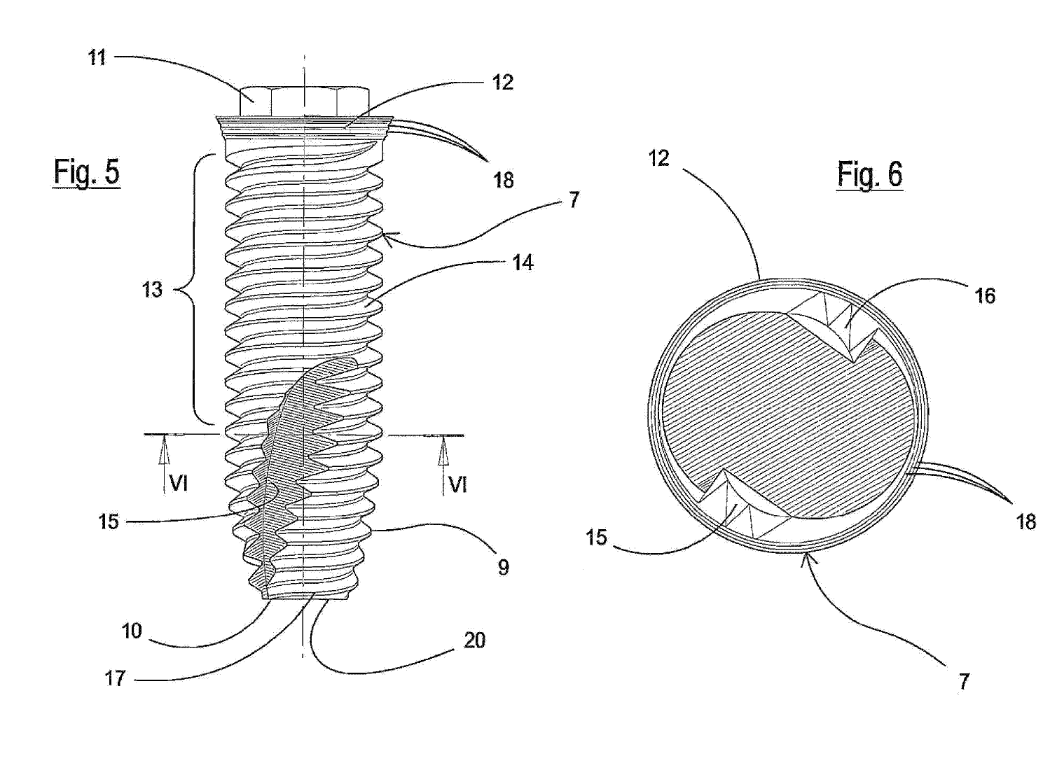

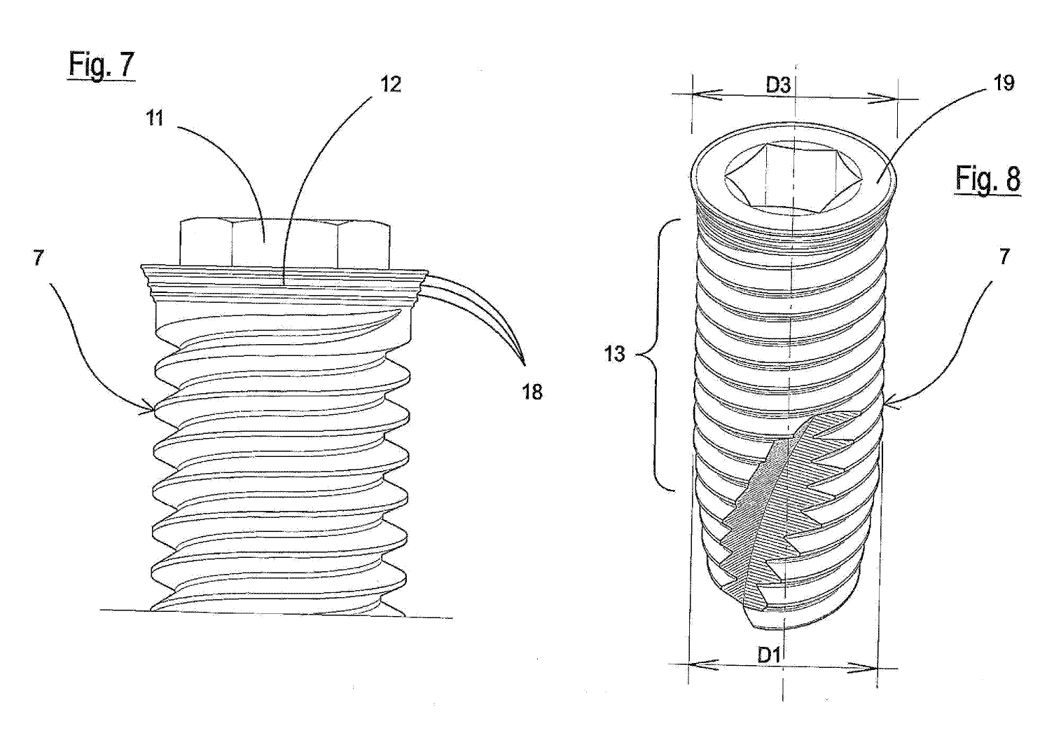

As illustrated in FIGS. 3 to 8, an implant 7 according to the invention has a head 12 which carries, internally (FIG. 8) or externally (FIG. 5) a prosthesis connection element 11. The body of the implant overlying the apical portion 9, indicated with 13 in FIG. 5, also has a slightly truncated-conical form.

The entire outer surface of the implant 7 has a double threading 14 which, in the apical portion 9 of the implant, is interrupted by at least two helical millings, 15 and 16, respectively. Due to their helical development, the millings 15 and 16 favor the outflow of bone chips and their discharge outside the above-mentioned seat 8 during the initial phase of the insertion of the implant, which is the most critical.

As illustrated in FIG. 5, the millings 15 and 16 terminate at the end 17 of the apical portion 9 of the implant 1.

The end 17 advantageously has a flat surface 20 with a substantially elliptical form, suitable for further favoring the insertion of the implant in the undersized seat 8.

The collar 12 of an implant 7 according to the invention, as better illustrated in FIG. 5, has microgrooves 18 transversally oriented with respect to the longitudinal axis of the implant and with an annular development. These microgrooves 18 contribute to the long-term stability of the implant on the bone margin.

The head portion of the implant 7 illustrated in FIG. 8 has a platform 19, whose diameter D3 is larger than the maximum diameter D1 of the body 13 of the implant.

Modifications can be applied to the invention, as described and illustrated in the figures, for creating variants which, in any case, fall within the scope of protection of the following claims.

Any combination of the above described characteristics can in fact be envisaged in a dental implant, starting from the feature related to the presence of a cutting edge on the end of the apical portion of the body of the implant.

The invention claimed is:

1. An endosseous dental implant comprising:
a head equipped with a collar (12) and a prosthesis connection element (11);
a body (13); and
an apical portion (9) provided with an end (17),
wherein said end (17) has an edge (10) with a sharp profile.

2. The endosseous dental implant according to claim 1, wherein said end (17) has a bottom (20) having an elliptical form.

3. The endosseous dental implant according to claim 2, wherein said endosseous dental implant comprises at least two millings (15, 16) with a helicoidal development at said apical portion (9).

4. The endosseous dental implant according to claim 2, wherein said endosseous dental implant comprises, on its outer surface, a double threading (14).

5. The endosseous dental implant according to claim 2, wherein said apical portion (9) has a truncated-conical shape.

6. The endosseous dental implant according to claim 5, wherein the body (13) of the implant (7) is tapered in the direction of said apical portion (9).

7. The endosseous dental implant according to claim 2, wherein said collar (12) has a plurality of microgrooves (18) transversally oriented with respect to a longitudinal axis of the implant and with an annular development.

8. The endosseous dental implant according to claim 2, wherein said collar (12) has a platform (19) having a larger diameter with respect to a maximum diameter of said body (13) of the endosseous dental implant (7).

9. The endosseous dental implant according to claim 1, wherein said endosseous dental implant has an outer surface with an average roughness Ra lower than 0.7 μm.

10. The endosseous dental implant according to claim 9, wherein said average roughness Ra is lower than 0.5 μm.
